(19) United States
(12) Patent Application Publication
(10) Pub. No.: US 2023/0099627 A1
(43) Pub. Date: Mar. 30, 2023

(54) MACHINE LEARNING MODEL FOR PREDICTING AN ACTION

(71) Applicant: Capital One Services, LLC, McLean, VA (US)

(72) Inventors: Staevan DUCKWORTH, Oak Point, TX (US); Micah PRICE, The Colony, TX (US); Avid GHAMSARI, Carrollton, TX (US); Qiaochu TANG, Frisco, TX (US); Geoffrey DAGLEY, McKinney, TX (US)

(21) Appl. No.: 17/448,773

(22) Filed: Sep. 24, 2021

(51) Int. Cl. G06N 20/00; G06Q 40/02

(52) U.S. Cl. CPC G06N 20/00; G06Q 40/025

(57) ABSTRACT

In some implementations, a system may input a set of values, for a corresponding set of features, to a machine learning model that is trained to predict a likelihood that a user will perform the action in connection with one or more entities. The set of values may be based on interactions of the user with one or more user interfaces associated with a plurality of entities. The system may execute the machine learning model on the set of values. The system may generate, based on executing the machine learning model on the set of values, an output indicative of the likelihood that the user will perform the action. The system may identify an entity, of the one or more entities, based on the output satisfying a threshold and may provide information to facilitate communication between the user and the entity.

### BACKGROUND

A machine learning model may be trained to recognize certain types of patterns. The machine learning model may be trained over a set of data (e.g., training data) provided to a machine learning algorithm that the machine learning model uses to reason over and learn from the training data. A trained machine learning model can be utilized to reason over new data and to make a prediction about the data based on the types of patterns the machine learning model has been trained to recognize.

### SUMMARY

In some implementations, a system for using machine learning to predict an action includes one or more memories and one or more processors, communicatively coupled to the one or more memories, configured to generate a plurality of clusters of entities, wherein each cluster of entities includes a set of entities that share similar characteristics; input a set of values, for a corresponding set of features, to a trained machine learning model that is trained to predict a set of likelihoods that a user will perform the action in connection with a corresponding set of clusters of entities, wherein the set of values includes one or more values that are indicative of one or more interactions of the user with one or more user interfaces associated with one or more entities included in the plurality of clusters of entities; generate, based on executing the trained machine learning model using the set of values, a set of outputs indicative of the set of likelihoods; identify a cluster of entities, of the plurality of clusters of entities, based on the set of outputs; identify an entity, included in the cluster of entities, based on user profile information associated with the user; and provide information to facilitate communication between the user and the entity based on identifying the entity.

In some implementations, a method of using machine learning to predict an action includes inputting, by a system, a set of values, for a corresponding set of features, to a trained machine learning model that is trained to predict a likelihood that a user will perform the action in connection with one or more entities, wherein the set of values are based on one or more interactions of the user with one or more user interfaces associated with a plurality of entities that include the one or more entities; executing, by the system, the trained machine learning model on the set of values; generating, by the system and based on executing the trained machine learning model on the set of values, an output indicative of the likelihood that the user will perform the action; identifying, by the system, an entity, of the one or more entities, based on the output satisfying a threshold; and providing, by the system, information to facilitate communication between the user and the entity based on identifying the entity.

In some implementations, a non-transitory computer-readable medium storing a set of instructions includes one or more instructions that, when executed by one or more processors of a system, cause the system to execute a trained machine learning model that is trained to predict a likelihood that a user will perform an action in connection with one or more entities, wherein the trained machine learning model is executed using a set of values, for a corresponding set of features, that are based on one or more interactions of the user with one or more user interfaces associated with a plurality of entities that include the one or more entities; generate, based on executing the trained machine learning model, an output that indicates the likelihood that the user will perform the action in connection with the one or more entities; identify an entity, of the one or more entities, based on the output satisfying a threshold; and provide information to facilitate communication between the user and the entity based on identifying the entity.

### BRIEF DESCRIPTION OF THE DRAWINGS

FIGS. 1A-1F are diagrams of an example implementation relating to utilizing a machine learning model for predicting an action.

FIG. 2 is a diagram illustrating an example of training and using a machine learning model in connection with utilizing a machine learning model for predicting an action.

FIG. 3 is a diagram of an example environment in which systems and/or methods described herein may be implemented.

FIG. 4 is a diagram of example components of one or more devices of FIG. 3.

FIG. 5 is a flowchart of an example process relating to utilizing a machine learning model for predicting an action.

### DETAILED DESCRIPTION

The following detailed description of example implementations refers to the accompanying drawings. The same reference numbers in different drawings may identify the same or similar elements.

Machine learning may be used to improve accuracy of behavior prediction. For example, a machine learning model may be trained and executed using a computer, such as a prediction system, to predict behavior of a user based on historical behaviors of that user and/or other users. As an example, user interactions with a website and/or computer application can be captured and used to predict behaviors or actions that might be performed by the user. However, there are several technical difficulties associated with executing machine learning models to make predictions. For example, the prediction system may need to obtain relevant inputs for a machine learning model by monitoring user interactions with a computer, website, or application and processing data captured during this monitoring to improve the accuracy of resulting outputs from the machine learning model. Furthermore, the prediction system may need to receive data from multiple data sources that store data in different formats. The prediction system may have difficulty determining whether inputs from one data source correspond to (e.g., are associated with the same user as) inputs from another data source. As a result, some data sets may have errors, which may result in inaccurate predictions.

Another technical difficulty may occur when the prediction system automatically generates content for a user based on a prediction associated with that user. For example, the prediction system may need to process a large amount of information, stored in various databases, to generate content that is relevant and customized for the user. It is technically difficult to generate customized content for a user due to the amount of information available and the different preferences each user may have, leading to large number of possible options of content that may be provided, which leads to technical difficulties with content generation and providing the content to the user in a form preferred by the user.

In some implementations described herein, a prediction system is provided that enables user interactions with computing devices to be monitored to determine a likelihood that a user will perform an action. For example, the prediction system may receive data based on user interactions with computing systems, websites, and/or computing applications. The data may be received in a particular format and/or formatted for input to a machine learning model to improve the accuracy of model predictions. In some implementations, the prediction system may receive data from multiple data sources, and may use identifiers included in the data to match corresponding data sets received from different data sources. In some implementations, the prediction system may analyze a most relevant subset of the large amount of information available to make accurate predictions using fewer processing resources as compared to analyzing all available information. In this way, the prediction system is able to accurately and efficiently analyze large amounts of computer-generated information to predict user behavior.

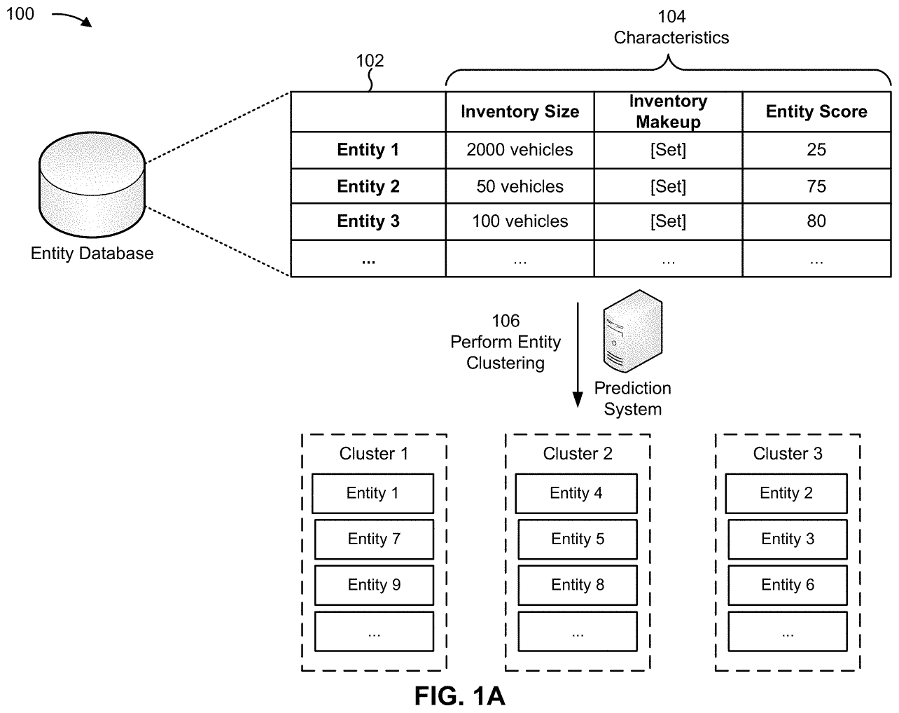

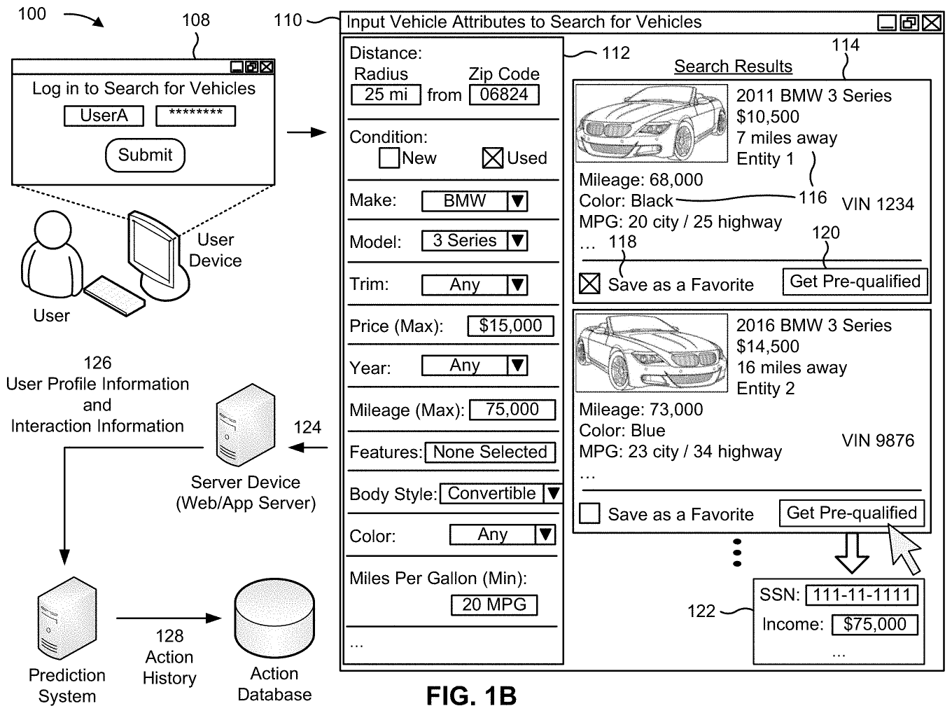

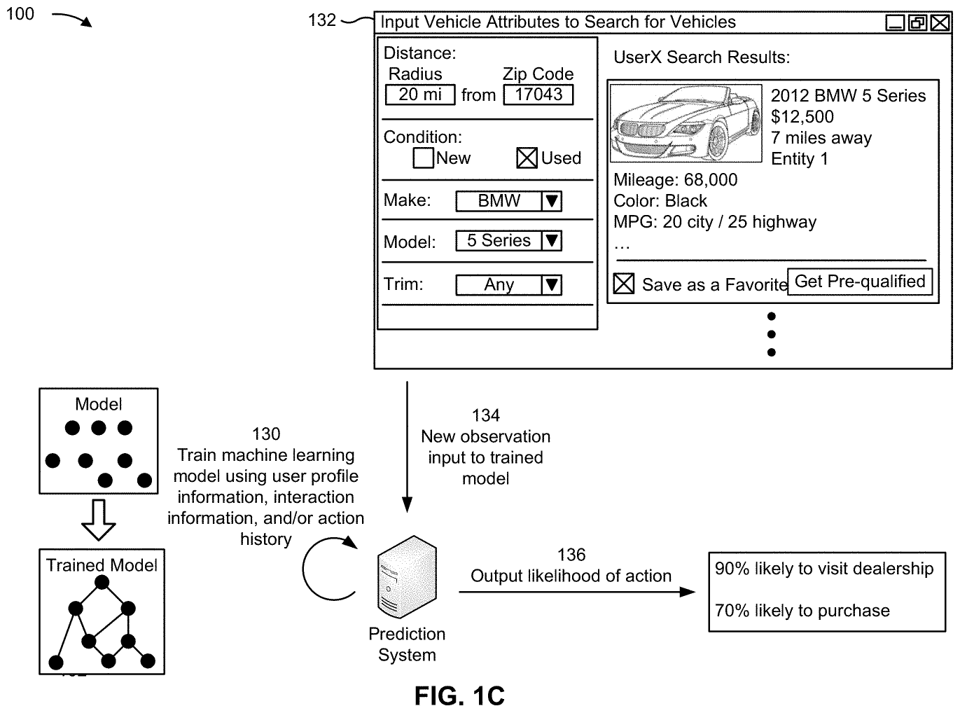

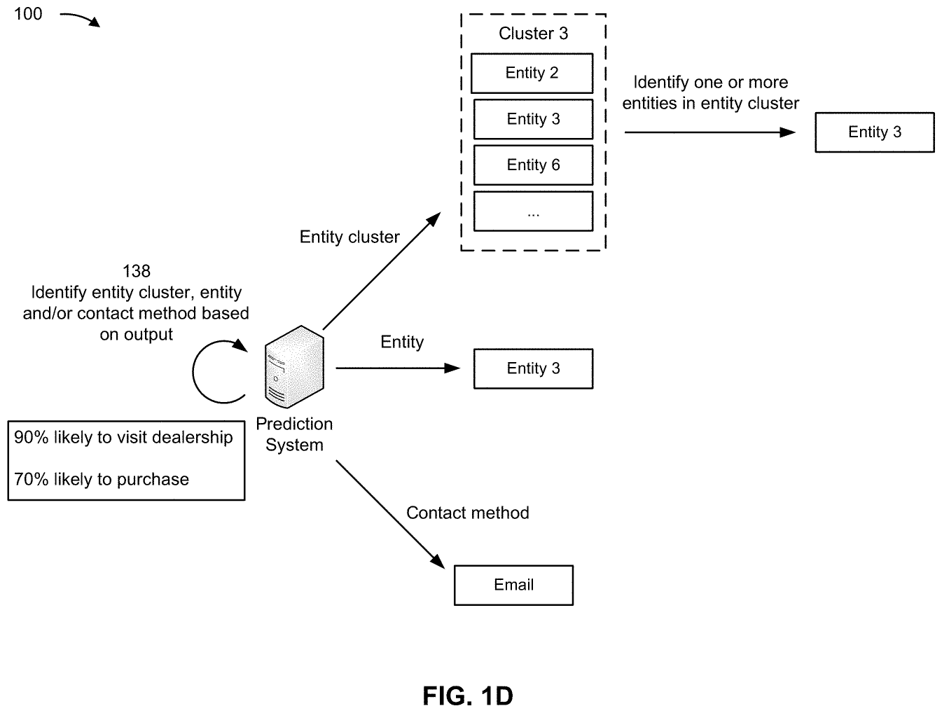

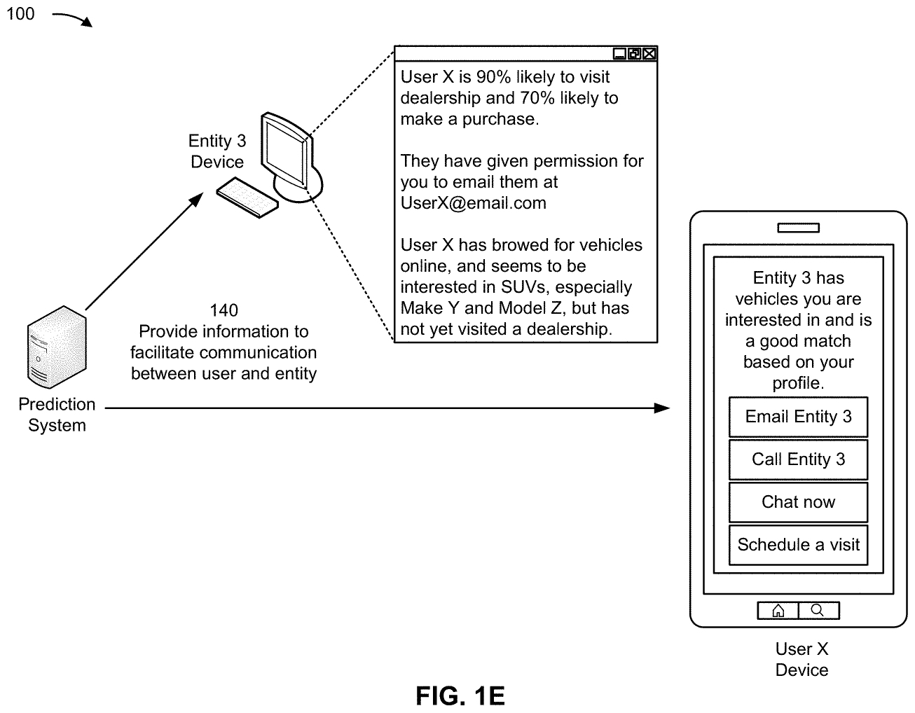

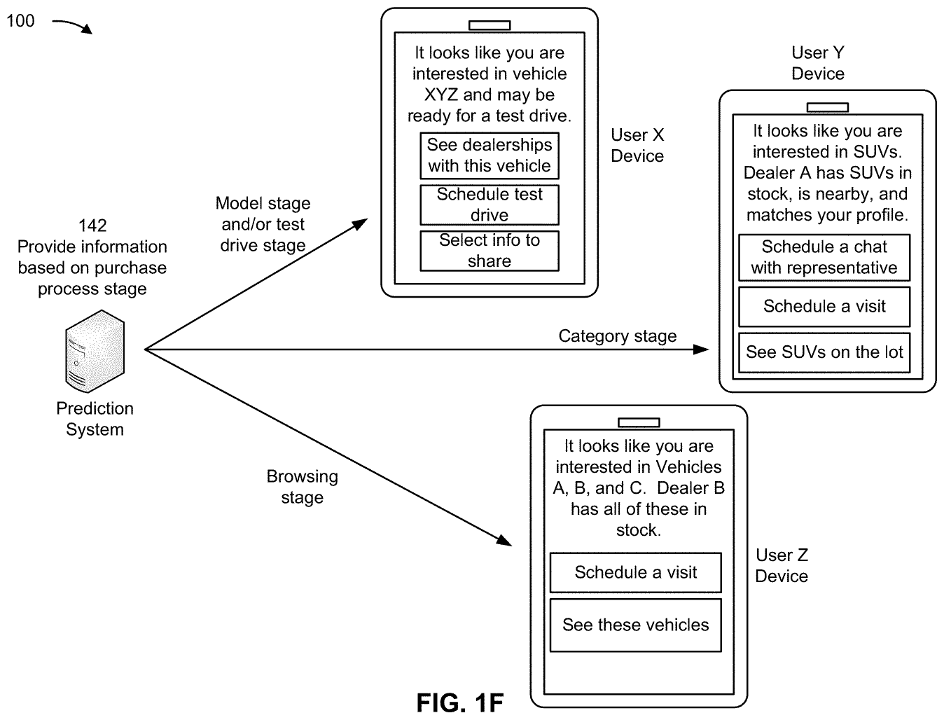

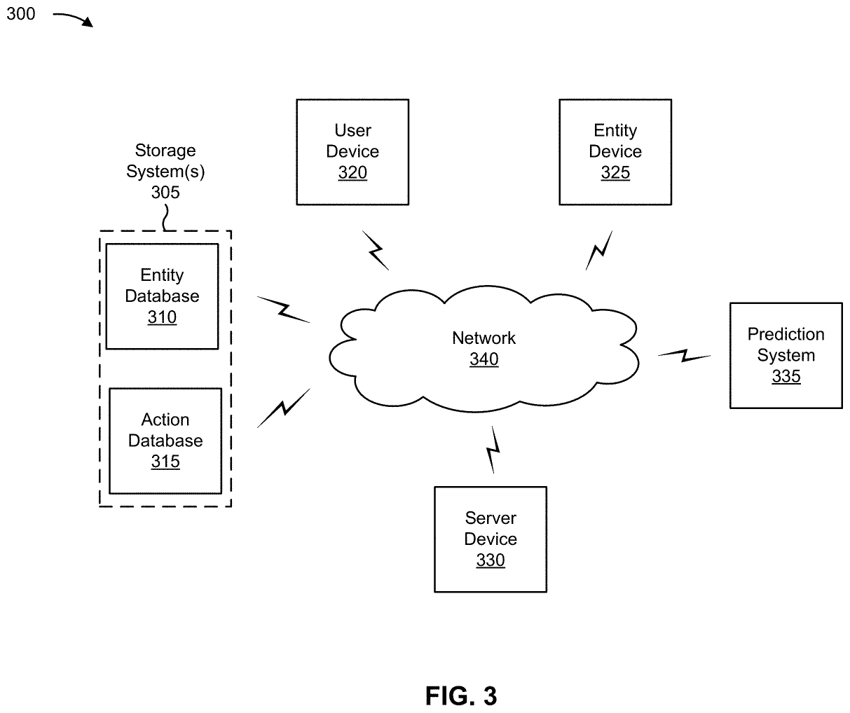

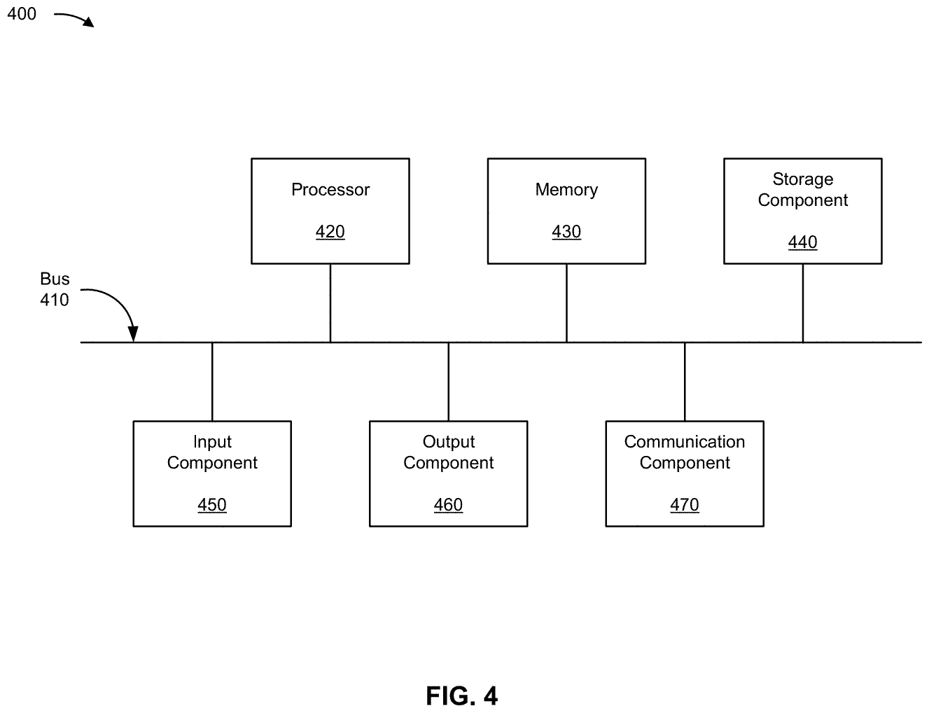

FIGS. 1A-1F are diagrams of an example 100 associated with utilizing a machine learning model for predicting an action. As shown in FIGS. 1A-1F, example 100 includes a prediction system, an entity database, an action database, a user device, a server device, and an entity device. These devices are described in more detail in connection with FIGS. 3 and 4.

As shown in FIG. 1A, and by reference number 102, the entity database may store information associated with multiple entities, sometimes referred to as “entity data.” An entity may be associated with providing (e.g., selling) a good or a service to a customer (e.g., a user). For example, an entity may be a merchant, a financial institution, a store, a car dealership, a general contractor, or a legal services organization, among other examples. In example 100, the entities are car dealerships (or more generally vehicle dealerships). Although FIGS. 1A-1F are described herein with respect to entities that are car dealerships, the entities may include any type of entity associated with providing a product and/or a service to a customer.

In some implementations, the entity data may include information that identifies the entity (e.g., a name of the entity or an entity identifier), shown as Entity 1, Entity 2, and Entity 3 in FIG. 1A. As shown by reference number 104, the entity data may include a set of (e.g., one or more) characteristics associated with the entities, sometimes referred to singularly as an “entity characteristic.” An entity characteristic may include information associated with a type of inventory carried by the entity (e.g., information indicating whether a car dealership sells new and/or used vehicles or information identifying a type of loan issued by a financial institution, among other examples), a size of the inventory (e.g., a quantity of items or a range of quantities of items offered by the entity), a quantity of different types of items included in the inventory (e.g., a quantity of different makes, models, and/or years of vehicles), a location of the entity, an entity score associated with the entity (e.g., a customer satisfaction score determined based on a set of reviews provided by customers of the entity, a score based on a quantity of complaints associated with the entity, a relationship score associated with the entity and a financial institution, and/or a business rating associated with the entity, among other examples), and/or information that identifies one or more products or services provided by the entity.

Additionally, or alternatively, an entity characteristic may include employee information associated with the entity, such as a quantity of employees, an experience level of one or more employees, a special skill of one or more employee (e.g., fluent in multiple languages or a particular language, high success rate selling to customers having a particular characteristic, and/or another type of customer service skill). Additionally, or alternatively, an entity characteristic may include an indication of one or more forms of communication utilized by the entity to communicate with customers. In example 100, the entity database stores information that indicates an inventory size for each entity, an inventory makeup (e.g., a quantity of new vehicles, a quantity of used vehicles, and/or a quantity of vehicles of different makes, models, and/or years) of each entity, and an entity score associated with each entity.

As shown by reference number 106, the prediction system may perform entity clustering to generate multiple clusters of entities. The prediction system may perform entity clustering based on the respective set of characteristics associated with each entity to generate clusters of entities sharing similar characteristics. For example, the prediction system may perform entity clustering to generate a cluster of car dealerships that sell new cars, a cluster of car dealerships that sell used cars, a cluster of car dealerships that sell new and used cars, a cluster of dealerships that sell a ratio of new cars to used cars that satisfies one or more thresholds (e.g., between two ratios), and/or a cluster of car dealerships that sell a particular make, model, and/or year of vehicle, among other examples.

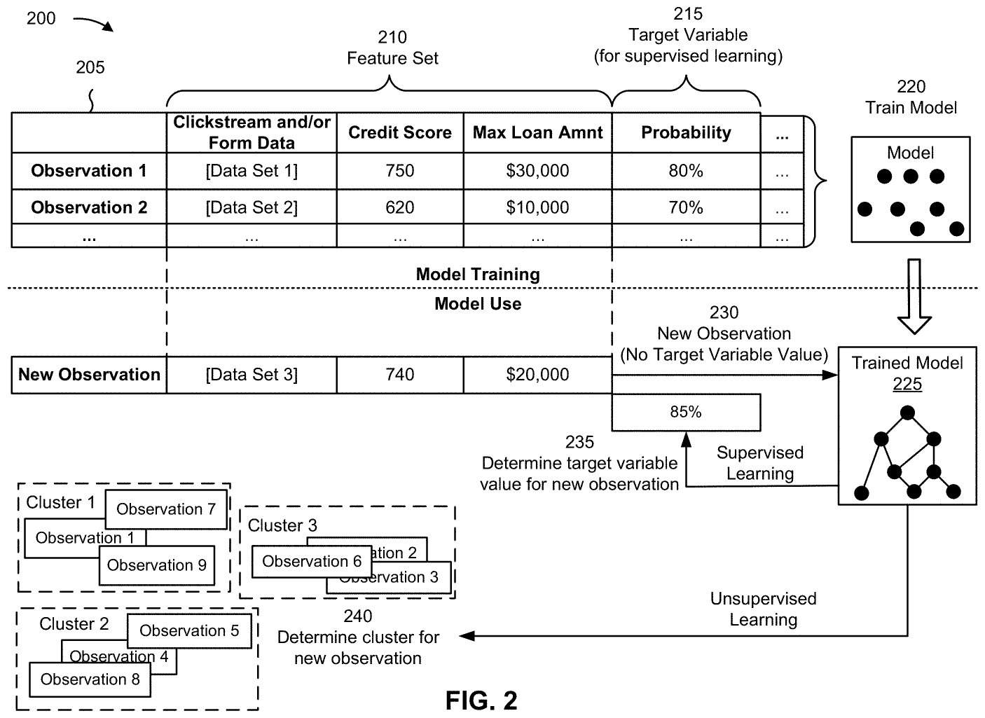

In some implementations, the prediction system may utilize a machine learning model to generate the clusters, as described in more detail elsewhere herein. For example, the prediction system may utilize a clustering model (e.g., a k-means clustering model) to generate the clusters based on the respective set of characteristics associated with each entity. In some implementations, a set of entity characteristics may be used as a feature set in machine learning to cluster entities, in a similar manner as described below in connection with FIG. 2.

As shown in FIG. 1B, a user interested in purchasing a vehicle may utilize a user device associated with the user to research and/or locate vehicles. As shown by reference number 108, the user may use the user device to log in (e.g., using credentials associated with the user) to a platform (e.g., via a user interface provided by an application or a web page associated with a car dealership, a vehicle manufacturer, a vehicle purchasing service, or a vehicle navigation or searching service) for searching for vehicle and/or for storing vehicle attribute preferences of the user. Although FIG. 1B shows the user logging in to a specific platform to search for a vehicle such that the user's interaction with the platform can be obtained, similar information regarding user interactions with other platforms (e.g., websites and/or applications) may be obtained in a similar manner. Such information may be stored in and/or accessible via a database.

As shown by reference number 110, the user (e.g., using the user device) may search for a vehicle using the platform based on inputting (e.g., via a user interface) a set of vehicle attribute categories. For example, as shown by reference number 112, the user may search for a vehicle using the platform based on inputting a set of vehicle attributes such as location (e.g., physical location of the vehicle), condition (e.g., new or used), make, model, trim, price (e.g., minimum price, maximum price, and/or a price range), year (a specific year, minimum year, a maximum year, and/or a range of years), current mileage (e.g., a maximum number of miles currently on the vehicle and/or a range of number of miles currently on the vehicle), features, body style, color, and/or fuel economy (e.g., a minimum miles per gallon (MPG) attribute of the vehicle), among other examples.

In some implementations, the user interface may enable the user to input information identifying an importance and/or a ranking of different vehicle attribute categories. For example, the user may indicate that fuel economy is more important to the user than make or model. As another example, the user may indicate that the condition (e.g., new or used) is more important than color. In some implementations, the user may rank the set of vehicle attribute categories from most important to least important. In some implementations, the platform (e.g., a server device associated with the platform) may determine or identify one or more vehicle attribute categories that are of interest to the user (e.g., without an explicit input from the user). For example, the server device may analyze one or more searches performed by the user via the platform, one or more vehicles indicated as being of interest to the user, and/or settings of the user profile in the platform to determine or identify one or more vehicle attribute categories that are of interest to the user. The server device may analyze a browsing history of the user when using the platform to determine or identify one or more vehicle attribute categories that are of interest to the user.

As shown by reference number 114, the platform may provide the user (e.g., via the user interface) with a search report that includes a group of search results indicating one or more matching vehicles based on the search input by the user. A search result may include information identifying vehicle attributes of a matching vehicle for one or more vehicle attribute categories. For example, as shown by reference number 116, a search result for a matching vehicle includes information identifying a color of the matching vehicle (e.g., a vehicle attribute category) as black (e.g., a vehicle attribute for the vehicle attribute category) and a location of the vehicle as being 7 miles away from a location input by the user (e.g., zip code 06824).

In some implementations, the user interface may enable the user to provide (e.g., via the user interface) an input indicating one or more vehicles in the search report as being of interest to the user. For example, as shown by reference number 118, the user interface includes an input field (e.g., “Save as Favorite”, as shown in FIG. 1B) that enables the user to save the one or more vehicles as a favorite and/or save information identifying the one or more vehicles to a user profile associated with the user.

In some implementations, the user interface may enable the user to perform one or more actions related to a search result. For example, as shown by reference number 120, the user interface may enable the user to select an option to get pre-qualified for a loan from a financial institution related to purchasing a vehicle identified in a search result. The user may interact with the user interface to select the option to begin a process associated with becoming pre-qualified for the loan.

As shown by reference number 122, the user interface may enable the user to input information associated with becoming pre-qualified for the loan based on the user interacting with the user interface to select the option to begin the process associated with becoming pre-qualified for the loan. For example, the user interface may display one or more text input fields through which the user can input information requested by a financial institution to pre-qualify the user for a loan. The user may input the requested information and the user interface (e.g., the server device associated with the user interface) may provide the input information to the financial institution. In some implementations, the user may input a user identifier (e.g., a social security number or another unique user identifier), and the user identifier may be used to associate information from different data sources, as described in more detail elsewhere herein.

As shown by reference number 124, content generated based on user interactions with the platform (e.g., searches performed, inputs, and/or browsing history) may be provided to the server device associated with the platform. As shown by reference number 126, the prediction system may receive (e.g., from the server device associated with the platform) user profile information and interaction information associated with the user. In some implementations, the user profile information and/or the interaction information may include information associated with the user (e.g., name, address, and/or phone number, among other examples) and/or information indicating one or more user interactions with the platform made via the user interface, such as information indicating one or more vehicle attribute categories that are of interest to the user, form data input into one or more fields of the user interface (e.g., information input by the user to become pre-qualified for the loan), one or more values or inputs for the one or more vehicle attribute categories, one or more vehicles that are of interest to the user, an indication of whether the user began the process to become pre-qualified for a loan, an indication of a result of the pre-qualification process, clickstream data, information identifying pages viewed by the user, a quantity of times the user accessed the platform during a time period (e.g., 1 hour, 1 day, 1 week), and/or an amount of time the user spent interacting with the platform, among other examples.

Alternatively, and/or additionally, the user profile information and/or the interaction information may include information associated with a user interaction with one or more other platforms and/or one or more other user interfaces. For example, the user profile information and/or the interaction information may include clickstream data associated with the one or more other platforms and/or the one or more other interfaces, form data input into one or more fields presented via the one or more other user interfaces, and/or application data (e.g., pages viewed, quantity of times the user utilizes the application during a time period, and/or quantity of time spent utilizing the application, among other examples) obtained by an application associated with the one or more other platforms and/or the one or more other interfaces, among other examples.

Additionally, or alternatively, the user profile information may indicate a preferred user experience for a user who visits an entity. For example, the user profile information may indicate whether the user prefers to browse at a dealership before being approached by a salesperson (and a length of time that the user likes to browse before being approached), whether the user prefers to be greeted immediately upon arrival by a salesperson, whether the user knows which vehicle they want, a type of vehicle that the user would like to see, or the like. In some implementations, the user may input information (e.g., into an application) to be communicated to a salesperson at the entity, such as the preferred user experience, information useful for physically identifying the person at a dealership (e.g., a picture of the user, information about clothing that the user is wearing, or the like), a reason for a purchase, information regarding any disabilities of the user to assist the salesperson, or the like. In some implementations, this information may be communicated to an entity device to facilitate communication between an entity and a user, as described in connection with FIG. 1E.

Additionally, or alternatively, the prediction system may predict the preferred user experience for a user. For example, the prediction system may predict the preferred user experience based on one or more user interactions with the platform made via the user interface, such as information indicating one or more vehicle attribute categories that are of interest to the user, form data input into one or more fields of the user interface, one or more values or inputs for the one or more vehicle attribute categories, one or more vehicles that are of interest to the user, an indication of whether the user began the process to become pre-qualified for a loan, an indication of a result of the pre-qualification process, clickstream data, information identifying pages viewed by the user, a quantity of times the user accessed the platform during a time period (e.g., 1 hour, 1 day, 1 week), and/or an amount of time the user spent interacting with the platform, among other examples.

As an example, if a user spends a threshold amount of time on the platform, accesses the platform a threshold quantity of times, spends a threshold amount of time researching a particular vehicle (e.g., determined based on interactions with web pages associated with the particular vehicle), and/or becomes pre-qualified for a loan via interaction with the platform, then this may indicate that the user is interested in purchasing the particular vehicle and prefers to be immediately approached by a salesperson upon arrival at a dealership rather than browsing the dealership. On the other hand, if a user does not spend a threshold amount of time on the platform, does not access the platform a threshold quantity of times, does not spend a threshold amount of time researching a particular vehicle, and/or does not become pre-qualified for a loan via interaction with the platform, then this may indicate that the user has not yet identified a particular vehicle of interest and prefers to browse the dealership rather than be immediately approached by a salesperson upon arrival at the dealership.

In some implementations, the prediction system may transmit an indication of the prediction of the preferred user experience to a user device associated with the user to allow the user to confirm the prediction via interaction with the user device. Additionally, or alternatively, the prediction system may transmit an indication of the prediction to an entity device associated with a dealership, such as based on user input to the user device (which may be transmitted to the prediction system) indicating that the user intends to visit a particular dealership, based on input from an entity device that identifies a user that is visiting the dealership or intends to visit the dealership (e.g., has scheduled a visit with the dealership), or the like. For example, the prediction system may receive, from an entity device, information that identifies a user. The prediction system may look up a stored prediction or may generate the prediction in real-time based on receiving the information that identifies the user. The prediction system may transmit the prediction to the entity device.

Additionally, or alternatively, the prediction system may receive, from a user device associated with the user, an indication that the user is visiting or plans to visit a dealership. For example, the user may provide input to the user device to indicate that the user will be visiting or is visiting the dealership, or a location of the user device may indicate that the user is at the dealership. Based on this indication, the prediction system may prompt the user (e.g., via transmitting a notification to the user device) of the prediction and ask the user to confirm the prediction or input a different preferred user experience. The prediction system may then provide the confirmed prediction or the different preferred user experience to an entity device associated with the dealership. In some implementations, the prediction system may identify a vehicle (e.g., a unique vehicle, a vehicle model, a vehicle make, a vehicle category, or the like) based on user interaction with the platform, and may prompt the user (e.g., via transmitting a notification to the user device) regarding whether the user is interested in seeing the vehicle. The prediction system may then provide information regarding the vehicle to an entity device associated with the dealership.

As shown by reference number 128, the prediction system may store, in an action database, the user profile information and/or the interaction information as action history associated with the user. The prediction system may populate a user profile associated with the user and stored in the action database with information included in the action history (e.g., information included in the user profile information and/or the interaction information). For example, the prediction system may store the action history (e.g., in the action database) as being associated with the user (e.g., using a user identifier). In some implementations, the prediction system may store the action history as being associated with the user by linking or mapping an identifier associated with the user (e.g., a user name, an identifier of the user device associated with the user, and/or an identifier of the user profile on the platform) with the action history in the action database.

In some implementations, the prediction system may store multiple action histories associated with the user. For example, the prediction system may store an action history associated with each occurrence of the user interacting with the platform occurring during a time period (e.g., a day, a week, and/or a time period beginning when the user logs in to the platform and ending when the user logs off of the platform, among other examples). Alternatively, and/or additionally, the prediction system may store an action history associated with each platform with which the user interacts. For example, the prediction system may store a first action history associated with the user interacting with a first platform and a second action history associated with the user interacting with a second, different platform. In some implementations, the first platform and the second platform are associated with the same entity. In some implementations, the first platform and the second platform are associated with different entities.

In some implementations, the prediction system may store a single action history associated with the user. The single action history may include action history associated with one or more occurrences of the user interacting with a first platform and action history associated with the user interacting with a second, different platform. In some implementations, the first platform and the second platform are associated with the same entity. In some implementations, the first platform and the second platform are associated with different entities. In some implementations, the first platform and the second platform are associated with related entities. For example, the first platform may be associated with a car dealership and the second platform may be associated with a financial institution (e.g., a financial institution performing a process for pre-qualifying the user with a loan and/or a financial institution in which the user has an account, among other examples).

In some implementations, historical information described in connection with FIG. 1B may be obtained for multiple users. For example, the prediction system may receive multiple sets of historical values corresponding to multiple historical users (e.g., based on historical interactions of those users with one or more user interfaces). In some implementations, the prediction system may receive a user identifier for a user, such as a unique user identifier, in connection with the historical values. At a later time, a historical user may purchase a vehicle and/or apply for financing (e.g., a loan) for a vehicle, and may use the same user identifier in connection with the purchase. The prediction system may receive this information, and may map historical values gathered in connection with user interactions to the purchase. This mapped data may then be used to train a machine learning model (as described below) to predict a likelihood of purchase based on user interactions by using historical data that ties user interactions of a user with a subsequent purchase by the user. Additionally, or alternatively, the prediction system may use the user identifier to search for a credit report and/or credit history of a user to identify whether the user purchased a vehicle (e.g., if an automobile loan appears on the credit history).

Additionally, or alternatively, the mapped data may be used to determine or predict a purchase process stage (e.g., a stage of a purchase process) associated with a user. A stage may indicate a breadth or narrowness of a user's interest in a purchase, such as a browsing or exploratory stage (with a broad focus on a large number of vehicles to potentially purchase), a category stage (with a narrower focus on a particular category of vehicles, such as sport utility vehicles, four-door sedans, or the like), a make stage (with a narrower focus on a particular make of vehicle), a model stage (with a still narrower focus on a particular make and model of vehicle), a unique vehicle stage (with a still narrower focus on a unique vehicle), or the like. Additionally, or alternatively, a stage may indicate one or more actions performed by the user in connection with shopping for a vehicle, such as a searching stage (e.g., triggered by the user searching for one or more vehicles), a prequalification stage (e.g., triggered by the user becoming prequalified for a vehicle), a dealership contact stage (e.g., triggered by the user contacting a dealership), a dealership visit stage (e.g., triggered by the user visiting a dealership), a test drive stage (e.g., triggered by the user test driving a vehicle), a purchase stage (e.g., triggered by a vehicle purchase), or the like.

In some implementations, the prediction system may determine the purchase process stage based on one or more user interactions with the platform and/or one or more actions performed by a user at a dealership (e.g., received via input to the user device and/or an entity device). The prediction system may transmit an indication of the stage to a user device associated with the user to allow the user to confirm the stage via interaction with the user device. Additionally, or alternatively, the prediction system may transmit an indication of the stage to an entity device associated with a dealership, such as based on user input to the user device (which may be transmitted to the prediction system) indicating that the user intends to visit a particular dealership, based on input from an entity device that identifies a user that is visiting the dealership or intends to visit the dealership (e.g., has scheduled a visit with the dealership), or the like. For example, the prediction system may receive, from an entity device, information that identifies a user. The prediction system may look up a stored stage or may determine or predict the stage in real-time based on receiving the information that identifies the user. The prediction system may transmit information that identifies the stage to the entity device.

As shown in FIG. 1C, and by reference number 130, the prediction system may train a machine learning model using user profile information, interaction information, and/or action history associated with users interested in purchasing a vehicle. In some implementations, the prediction system may train the machine learning model to predict a set of likelihoods that the user will perform an action in connection with a set of clusters of entities based on one or more of user profile information, interaction information associated with the user interacting with a platform, and/or an action history associated with the user. The action may include an exchange, such as a purchase of a vehicle and/or a trade (e.g., a user trading in a current vehicle on a purchase of a new vehicle), among other examples. Additionally, or alternatively, the action may include an entity visit, such as a user going to a physical location of the entity (e.g., a car dealership).

The machine learning model may be trained based on historical data relating to users interested in purchasing a vehicle. The machine learning model may be trained to determine, based on information regarding a user associated with purchasing a vehicle, a set of likelihoods that a user will perform a set of actions related to purchasing a vehicle with a set of clusters of entities and a set of confidence scores that reflect measures of confidence that each likelihood is accurate for a respective action included in the set of actions. In some implementations, the prediction system trains the machine learning model in a manner similar to that described below with respect to FIG. 2. Alternatively, and/or additionally, the prediction system may obtain a trained machine learning model from another device.

As shown by reference number 132, the prediction system may receive data associated with one or more interactions of a user with one or more interfaces associated with one or more entities. For example, the prediction system may retrieve the action history associated with the user interacting with the platform from the action database. In some implementations, the action database may include multiple action histories associated with the user and the prediction system may retrieve one or more of the multiple action histories associated with the user from the action database.

In some implementations, the prediction system may receive the data associated with the one or more interactions of the user with the one or more interfaces based on receiving a request from an entity. For example, an entity (e.g., an employee of an entity) may interact with a user regarding a purchase of a vehicle and the entity (e.g., a device associated with the entity) may provide a request for information indicating a likelihood that the user will perform an action related to the purchasing of a vehicle to the prediction system.

Alternatively, and/or additionally, the prediction system may receive the data associated with the one or more interactions of the user with the one or more interfaces based on one or more other factors. For example, the prediction system may receive the data associated with the one or more interactions of the user with the one or more interfaces based on the user interacting with the platform, the prediction system receiving user profile information and/or user interaction information associated with the user interacting with the platform, the prediction system storing action history associated with the user in the action database, and/or a quantity of action histories stored in the action database and associated with the user satisfying a quantity threshold, among other examples.

In some implementations, the prediction system may generate a set of values that includes one or more values that are indicative of the one or more interactions of the user with the one or more interfaces based on the data associated with the one or more interactions of the user with the one or more interfaces. In some implementations, the set of values may include and/or may be determined based on clickstream data associated with the one or more interfaces, form data input into one or more fields presented via the one or more user interfaces, and/or application data (e.g., pages viewed, quantity of times the user utilizes the application during a time period, and/or quantity of time spent utilizing the application, among other examples) obtained by an application associated with the one or more interfaces, among other examples. Alternatively, and/or additionally, the set of values may include a credit score of the user, a loan amount associated with the user, a maximum loan amount associated with the user, an indication of whether the user has interacted with one or more user interfaces to prequalify for a loan, an indication of whether the user has interacted with a loan calculator presented via the one or more user interfaces, an indication of whether the user has input a trade-in value for a vehicle via the one or more user interfaces, and/or an indication of whether the user has interacted with a user interface, of the one or more user interfaces, that presents rebate information, warranty information, or insurance information, among other examples.

In some implementations, the set of values may include and/or be determined based on information associated with a product or service. For example, the set of values may include and/or be determined based on a type of product or service, a manufacturer associated with a product or service, a model associated with a product, a quantity of time spent viewing information related to the product or service, aesthetic information (e.g., color, size, and/or shape, among other examples), and/or a quantity of items associated with the product or the service viewed by the user, among other examples.

As shown by reference number 134, the prediction system may input a new observation to the trained machine learning model. The new observation may include the values based on the data associated with the one or more interactions of the user with the one or more interfaces, as described in greater detail below with respect to FIG. 2.

As shown by reference number 136, the prediction system may generate, based on executing the trained machine learning model using the set of values, a set of outputs indicative of a set of likelihoods that the user will perform one or more actions with a set of clusters of entities. For example, as shown in FIG. 1C, the prediction system outputs information indicating a likelihood that the user will visit a dealership associated with an entity included in a set of clusters of entities and a likelihood that the user will purchase a vehicle from an entity included in the set of clusters of entities.

Additionally, or alternatively, the prediction system may cluster users, and may assign the user to a cluster, as described in more detail in connection with FIG. 2. In some implementations, each cluster of users may be associated with a different range of probabilities of a purchase or an entity visit. Additionally, or alternatively, each cluster of users may be associated with a different stage of a purchase process (e.g., early stage before pre-qualification, late stage after pre-qualification, or the like). In some implementations, the prediction system may identify an entity, a cluster of entities, or a salesperson at an entity based on the cluster to which a user is assigned. For example, certain dealerships or salespeople may be better at working with early stage users or users that are less likely to buy, while other dealerships or salespeople may be better at working with late stage users or users that are more likely to buy. Additionally, or alternatively, the prediction system may identify a contact method to be used to facilitate communication between a user and an entity based on a cluster to which the user is assigned, as described in more detail below in connection with FIG. 2.

In some implementations, the set of outputs includes a respective output for each cluster of entities. For example, the set of outputs may include a first output for a first cluster of entities indicating a likelihood that the user will visit a dealership associated with an entity included in the first cluster of entities and a likelihood that the user will purchase a vehicle from an entity included in the first cluster of entities. The set of outputs may include a second output for a second cluster of entities indicating a likelihood that the user will visit a dealership associated with an entity included in the second cluster of entities and a likelihood that the user will purchase a vehicle from an entity included in the second cluster of entities.

In some implementations, an output in the set of outputs may include information indicating a contact method preferred by the user. The prediction system may generate, based on executing the trained machine learning model and/or another trained machine learning model using the set of values, a set of outputs indicative of a set of contact methods (e.g., telephone, in-person, text, and/or email, among other examples) preferred by the user. For example, the prediction system may determine that email is the preferred contact method of the user. Example contact methods include email, phone, in-app messaging, browser chat, and a chatbot. In some implementations, a user interaction with a website or application may indicate a preference for a particular contact method. For example, user interaction with a chat program may indicate that the user prefers electronic (non-phone) communications like chat, text, or email. As another example, if a user inputs multiple phone numbers into a form (e.g., home phone number, work phone number, and cell phone number), then this may indicate that the user prefers phone communications.

In some implementations, the prediction system determines the preferred contact method based on the action history associated with the user. For example, the action history may include user interaction information indicating one or more contact methods utilized by the user to communicate with an entity. The prediction system may determine the preferred contact method based on the one more contact methods utilized by the user. For example, the prediction system may determine the preferred contact method based on the contact method utilized most often by the user relative to other contact methods.

In some implementations, the action history associated with the user includes user profile information indicating a preferred contact method associated with the user. For example, the user may enter information indicating a preferred contact method via the user interface associated with the platform when registering with a service provided by the platform, creating a user account, and/or searching for vehicles, among other examples.

In some implementations, an output in the set of outputs may include information indicating a customer experience preferred by the user. For example, the prediction system may generate, based on executing the trained machine learning model and/or another trained machine learning model using the set of values, a set of outputs indicative of a customer experience (e.g., performing the entire purchase process on-line, scheduling an appointment to test drive a vehicle at the dealership, and/or having the vehicle delivered to a home of the user upon purchasing the vehicle, among other examples) preferred by the user.

In some implementations, the prediction system determines the preferred customer experience based on the action history associated with the user. For example, the action history may include user interaction information associated with one or more customer experiences of the user. The prediction system may determine the preferred customer experience for the user based on the user interaction information associated with the one or more customer experiences of the user.

In some implementations, the user interaction information associated with the one or more customer experiences of the user includes a review of an entity written by the user. For example, the user may submit a review of an entity via the platform and/or post a review of an entity to a web site, among other examples. The review may include information indicating an action performed by the entity that pleased the user, an action the entity failed to perform, and/or an action performed by the entity that displeased the user, among other examples. The prediction system may determine the preferred customer experience based on the information included in the review.

In some implementations, the action history associated with the user includes user profile information indicating a preferred customer experience associated with the user. For example, the user may enter information indicating a preferred customer experience via the user interface associated with the platform when registering with a service provided by the platform, creating a user account, and/or searching for vehicles, among other examples.

As shown in FIG. 1D, and by reference number 138, the prediction system may identify a cluster of entities, an entity, and/or a contact method based on the set of outputs. In some implementations, the prediction system may identify a cluster of entities based on the likelihood of the user performing an action with an entity included in the cluster of entities. For example, the prediction system may identify a cluster of entities associated with a highest likelihood of the user performing an action with an entity included in the cluster of entities relative to likelihoods associated with other clusters of entities.

In some implementations, the prediction system may identify an entity included in the identified cluster of entities based on the likelihood of the user performing an action with the entity. For example, the prediction system may identify an entity included in the cluster of entities that is associated with a highest likelihood of the user performing an action with the entity relative to likelihoods associated with other entities included in the cluster of entities and/or an entity associated with a likelihood of the user performing an action with the entity that satisfies a threshold (e.g., 75%, 80%, or 90%, among other examples). Alternatively, and/or additionally, the prediction system may identify an entity included in the cluster of entities based on the entity being able to utilize a method of contact preferred by the user and/or the entity being able to provide the user with a customer experience similar to the customer experience preferred by the user.

As shown in FIG. 1E, and by reference number 140, the prediction system may provide information to facilitate communication between the user and the entity. In some implementations, the prediction system may provide information to facilitate communication between the user and the entity to a user device associated with the user. For example, the prediction system may provide information identifying the entity and/or contact information associated with the entity, among other examples, to the user device. In some implementations, the prediction system may provide an input via a user interface of a user device associated with the user to enable the user to contact (e.g., call, text, or email, among other examples) the entity. For example, as shown in FIG. 1E, the prediction system may provide, via a user interface, information identifying the entity and a set of inputs that enable the user to contact the entity via email, telephone, chat, and/or to schedule a visit.

Alternatively, and/or additionally, the prediction system may provide information to facilitate communication to the user and the entity to an entity device associated with the entity. In some implementations, the information provided to the entity by the prediction system may include information identifying the user (e.g., a name of the user), information identifying the likelihood of the user performing an action with the entity, information indicating that the user has been provided contact information associated with the entity, contact information for the user, information identifying the contact method preferred by the user, information identifying the preferred customer experience associated with the user, information identifying a purchase process stage associated with the user, and/or information indicating that the user has given permission for the prediction system to provide the user's information to the entity and/or for the entity to contact the user, among other examples.

In some implementations, the information provided to the entity device may depend on the purchase process stage associated with the user. For example, for a browsing or searching stage, the information may include information identifying the user and contact information for the user. For a category stage, the information may include the above information and a category of vehicle in which the user is interested. For a make stage, the information may include the above information and a make of vehicle in which the user is interested. For a model stage, the information may include the above information and a model of vehicle in which the user is interested. For a unique vehicle stage, the information may include the above information and information that identifies a unique vehicle (e.g., using a vehicle identification number) in which the user is interested. For a prequalification stage, the information may include prequalification information or other financial information associated with the user. For a test drive stage, the information may include driver's license information.

For example, as shown in FIG. 1E, the prediction system may provide information about the purchase process stage, such as one or more purchase process stages that have been completed by the user (e.g., “User X has browed for vehicles online”) and/or one or more purchase process stages that have not been completed by the user (e.g., “User X . . . has not yet visited a dealership”). Additionally, or alternatively, the prediction system may provide information regarding vehicles in which the user is interested (e.g., “User X . . . seems to be interested in SUVs, especially Make Y and Model Z”).

In some implementations, the prediction system may cluster users, and may assign the user to a cluster, as described in more detail in connection with FIG. 2. For example, each cluster of users may be associated with a different range of probabilities of a purchase or an entity visit and/or a different stage of a purchase process. In some implementations, the prediction system may provide different information of a user to the entity device and/or the user device based on a cluster to which the user is assigned. For example, the prediction system may provide more information about a user if the user is more likely to buy, and may provide less information about a user if the user is less likely to buy.

As shown in FIG. 1F, and by reference number 142, the prediction system may transmit information to the user device based on a purchase process stages associated with a user of the user device. For example, if the user is in a model stage (where user interactions indicate that the user has identified a model of vehicle that the user is interested in) and/or a test drive stage (e.g., where the user has shown interest in a vehicle but not yet test driven the vehicle), the prediction system may transmit a recommendation to test drive the vehicle. In this case, the prediction system may identify dealerships that have the vehicle, and may recommend those dealerships to the user. The notification may include various options that are selectable by the user, which may be different for different stages. For example, for the model stage and/or test drive stage, the options may include viewing dealerships that have the vehicle in stock, scheduling a test drive, and/or selecting the information to be shared with a dealership with which a test drive is scheduled.

As another example, if the user is in a category stage (where user interactions indicate that the user is interested in a particular category of vehicle), the prediction system may transmit a recommendation that identifies a dealership that has a threshold number of SUVs in stock, that is located near the user, and/or that has characteristics that match a user profile (e.g., based on the preferred customer experience, a dealership rating, an entity cluster, or the like). The selectable options for the category stage may include scheduling a call with a representative from a recommended dealership, scheduling a visit to the recommended dealership, viewing SUVs that the dealership has in stock (e.g., via a web site), and/or selecting the information to be shared with the dealership (e.g., to initiate contact, share vehicles in which the user is interested, or the like).

As another example, if the user is in a browsing stage (where user interactions indicate that the user has viewed a few different types of vehicles but has not identified a particular vehicle of interest), the prediction system may transmit a recommendation that identifies a dealership that has the vehicles browsed by the user in stock, that is located near the user, and/or that has characteristics that match a user profile (e.g., based on the preferred customer experience, a dealership rating, an entity cluster, or the like). The selectable options for the category stage may include scheduling a visit to the recommended dealership to view the vehicles in person, viewing the vehicles that the dealership has in stock that are of interest to the user (e.g., via a web site), and/or selecting the information to be shared with the dealership (e.g., to initiate contact, share vehicles in which the user is interested, or the like).

As described herein, the prediction system may enable a likelihood of a potential customer (e.g., a user) performing an action to be determined more accurately and may facilitate communication between the customer and an entity that is able to provide a preferred user experience to the user via a preferred contact method of the user.

As indicated above, FIGS. 1A-1F are provided as an example. Other examples may differ from what is described with regard to FIGS. 1A-1F.

FIG. 2 is a diagram illustrating an example 200 of training and using a machine learning model in connection with utilizing a machine learning model for predicting an action. The machine learning model training and usage described herein may be performed using a machine learning system. The machine learning system may include or may be included in a computing device, a server, a cloud computing environment, or the like, such as the prediction system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the prediction system, the server device, the entity database, and/or the action database, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the prediction system, the server device, the entity database, and/or the action database. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of clickstream data and/or form data, a second feature of credit score, a third feature of maximum loan amount, and so on. As shown, for a first observation, the first feature may have a value indicating a set of data points for clickstream data and/or form data (e.g., a sequence of web pages visited by the user, a sequence of user interactions with a web page or multiple web pages, a time between user interactions, a time spent on a web page, a form filled out by the user, and/or one or more values input by the user into the form), the second feature may have a value of 750, the third feature may have a value of $30,000, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is probability of exchange (e.g., purchase), which has a value of 80% for the first observation. In some implementations, the target variable may be a probability of an entity visit.

The feature set and target variable described above are provided as examples, and other examples may differ from what is described above. For example, for a target variable of preferred contact method, the feature set may include the features described elsewhere herein and/or other features, such as form data indicating a reason for facilitating a communication between the user and an entity, such as inquiring about the price of a vehicle, scheduling a test drive, and/or discussing financing options.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of clickstream data and/or form data, a second feature of credit score, a third feature of maximum loan amount, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 85% for the target variable of probability for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to facilitate communication between a user and an entity associated with the new observation. The first automated action may include, for example, automatically providing information associated with the entity to the user and/or automatically providing information associated with the user to the entity.

As another example, if the machine learning system were to predict a value of 40% for the target variable of probability, then the machine learning system may provide a second (e.g., different) recommendation (e.g., a recommendation to limit an amount of resources associated with trying to get the user to purchase a vehicle) and/or may perform or cause performance of a second (e.g., different) automated action (e.g., automatically providing information to the entity indicating that the user is not likely to purchase a vehicle from the entity).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a likely to purchase cluster), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., a likely to visit the entity cluster), then the machine learning system may provide a second (e.g., different) recommendation (e.g., a recommendation to contact the user to schedule a visit) and/or may perform or cause performance of a second (e.g., different) automated action, such as automatically providing information associated with visiting the entity to the user.

As another example, if the machine learning system were to classify the new observation in a third cluster (e.g., a not likely to purchase a vehicle cluster), then the machine learning system may provide a third (e.g., different) recommendation (e.g., a recommendation to not contact the user) and/or may perform or cause performance of a third (e.g., different) automated action, such as automatically providing, to the entity, information indicating that the user is unlikely to purchase a vehicle from the entity.

In some implementations, the machine learning model may cluster users based on a likelihood of purchase. For example, different clusters may correspond to users with different ranges of likelihood of purchase (e.g., 0-25%, 25%-50%, 50%-75%, and 75%-100%). In some implementations, the machine learning model may provide different recommendations and/or may perform different actions based on a cluster to which a user is assigned. For example, the machine learning model may recommend users in different clusters to different dealerships, may recommend different contact methods (e.g., do not contact users who are 0-25% likely to buy, send an email for users who are 25%-50% likely to buy, send a text message to users who are 50%-75% likely to buy, and call users who are 75%-100% likely to buy). In some implementations, the prediction system may provide different information to an entity based on a cluster to which a user is assigned. For example, less information may be provided (e.g., name and email address) for users who are less likely to buy, whereas more information may be provided (e.g., name, email address, phone number, and credit score) for users who are more likely to buy. Additionally, or alternatively, the prediction system may recommend a different type of salesperson based on the cluster to which a user is assigned. For example, early stage customers who are less likely to buy may be referred to a salesperson who is more experienced with learning customer preferences and showing a lot of cars, whereas late stage customers who are more likely to buy may be referred to a salesperson who is experienced with closing sales quickly.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In this way, the machine learning system may apply a rigorous and automated process to determine a likelihood of a user performing an action with an entity. The machine learning system enables recognition and/or identification of tens, hundreds, thousands, or millions of features and/or feature values for tens, hundreds, thousands, or millions of observations, thereby increasing accuracy and consistency and reducing delay associated with determining a likelihood of a user performing an action with an entity relative to requiring computing resources to be allocated for tens, hundreds, or thousands of operators to manually determining a likelihood of a user performing an action with an entity using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a storage system 305 that includes an entity database 310 and an action database 315, a user device 320, an entity device 325, a server device 330, a prediction system 335, and a network 340. Devices of environment 300 may interconnect via wired connections, wireless connections, or a combination of wired and wireless connections.

The storage system 305 includes one or more devices capable of receiving, generating, storing, processing, and/or providing user profile information, interaction information, and action history information, as described elsewhere herein. The storage system 305 may include a communication device and/or a computing device. For example, the storage system 305 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The storage system 305 may communicate with one or more other devices of environment 300, as described elsewhere herein.

The entity database 310 includes one or more devices capable of receiving, generating, storing, processing, and/or providing information associated with one or more entities, as described elsewhere herein. The entity database 310 may include a communication device and/or a computing device. For example, the entity database 310 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The entity database 310 may communicate with one or more other devices of environment 300, as described elsewhere herein.

The action database 315 includes one or more devices capable of receiving, generating, storing, processing, and/or providing user profile information, interaction information, and action history information, as described elsewhere herein. The action database 315 may include a communication device and/or a computing device. For example, the action database 315 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The action database 315 may communicate with one or more other devices of environment 300, as described elsewhere herein.

The user device 320 includes one or more devices capable of receiving, generating, storing, processing, and/or providing information associated with utilizing a machine learning model for predicting an action, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The entity device 325 includes one or more devices capable of receiving, generating, storing, processing, and/or providing information associated with utilizing a machine learning model for predicting an action, as described elsewhere herein. The entity device 325 may include a communication device and/or a computing device. For example, the entity device 325 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The server device 330 includes one or more devices capable of receiving, generating, storing, processing, providing, and/or routing information associated with utilizing a machine learning model for predicting an action, as described elsewhere herein. The server device 330 may include a communication device and/or a computing device. For example, the server device 330 may include a server, such as an application server, a client server, a web server, a database server, a host server, a proxy server, a virtual server (e.g., executing on computing hardware), or a server in a cloud computing system. In some implementations, the server device 330 includes computing hardware used in a cloud computing environment.

The prediction system 335 includes one or more devices capable of receiving, generating, storing, processing, providing, and/or routing information associated with utilizing a machine learning model for predicting an action, as described elsewhere herein. The prediction system 335 may include a communication device and/or a computing device. For example, the prediction system 335 may include a server, such as an application server, a client server, a web server, a database server, a host server, a proxy server, a virtual server (e.g., executing on computing hardware), or a server in a cloud computing system. In some implementations, the prediction system 335 includes computing hardware used in a cloud computing environment.

The network 340 includes one or more wired and/or wireless networks. For example, the network 340 may include a cellular network (e.g., a fifth generation (5G) network, a fourth generation (4G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the storage system 305, the entity database 310, the action database 315, the user device 320, the entity device 325, the server device 330, and/or the prediction system 335. In some implementations, the storage system 305, the entity database 310, the action database 315, the user device 320, the entity device 325, the server device 330, and/or the prediction system 335 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

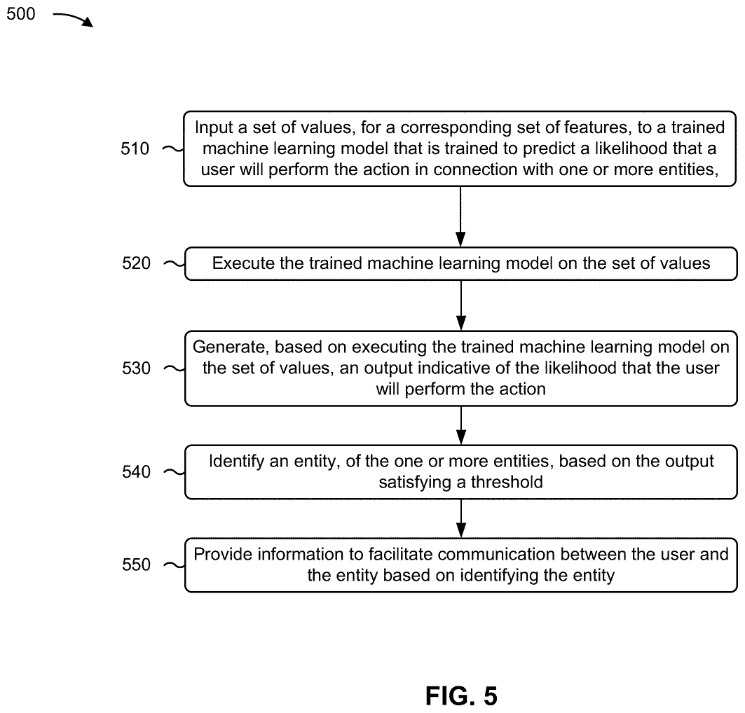

FIG. 5 is a flowchart of an example process 500 associated with utilizing a machine learning model for predicting an action. In some implementations, one or more process blocks of FIG. 5 may be performed by a system (e.g., prediction system 335). In some implementations, one or more process blocks of FIG. 5 may be performed by another device or a group of devices separate from or including the system, such as a storage system (e.g., the storage system 305), a database (e.g., the entity database 310, and/or the action database 315), a user device (e.g., the user device 320), an entity device (e.g., the entity device 325), and/or a server device (e.g., the server device 330). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include inputting a set of values, for a corresponding set of features, to a trained machine learning model that is trained to predict a likelihood that a user will perform the action in connection with one or more entities (block 510). In some implementations, the set of values may be based on one or more interactions of the user with one or more user interfaces associated with a plurality of entities that include the one or more entities As further shown in FIG. 5, process 500 may include executing the trained machine learning model on the set of values (block 520). As further shown in FIG. 5, process 500 may include generating, based on executing the trained machine learning model on the set of values, an output indicative of the likelihood that the user will perform the action (block 530). As further shown in FIG. 5, process 500 may include identifying an entity, of the one or more entities, based on the output satisfying a threshold (block 540). As further shown in FIG. 5, process 500 may include providing information to facilitate communication between the user and the entity based on identifying the entity (block 550).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using machine learning to predict an action, the system comprising:
one or more memories; and
one or more processors, communicatively coupled to the one or more memories, configured to:
generate a plurality of clusters of entities, wherein each cluster of entities includes a set of entities that share similar characteristics;
input a set of values, for a corresponding set of features, to a trained machine learning model that is trained to predict a set of likelihoods that a user will perform the action in connection with a corresponding set of clusters of entities,
wherein the set of values includes one or more values that are indicative of one or more interactions of the user with one or more user interfaces associated with one or more entities included in the plurality of clusters of entities;
generate, based on executing the trained machine learning model using the set of values, a set of outputs indicative of the set of likelihoods;
identify a cluster of entities, of the plurality of clusters of entities, based on the set of outputs;
identify an entity, included in the cluster of entities, based on user profile information associated with the user; and
provide information to facilitate communication between the user and the entity based on identifying the entity.

2. The system of claim 1, wherein the one or more processors are further configured to:
identify a contact method for the user based on applying the trained machine learning model or another trained machine learning model to the set of values; and
provide information that identifies the contact method in connection with the information to facilitate communication between the user and the entity.

3. The system of claim 1, wherein the one or more processors are further configured to:
identify a contact method for the user based on the user profile information; and
provide information that identifies the contact method in connection with the information to facilitate communication between the user and the entity.

4. The system of claim 1, wherein the set of values includes or is determined based on at least one of:
clickstream data associated with the one or more user interfaces, or
form data input into one or more fields presented via the one or more user interfaces.

5. The system of claim 1, wherein the set of values includes at least one of:
a credit score of the user,
a loan amount associated with the user,
a maximum loan amount associated with the user,
an indication of whether the user has interacted with the one or more user interfaces to prequalify for a loan,
an indication of whether the user has interacted with a loan calculator presented via the one or more user interfaces,
an indication of whether the user has input a trade-in value for a vehicle via the one or more user interfaces, or
an indication of whether the user has interacted with a user interface, of the one or more user interfaces, that presents rebate information, warranty information, or insurance information.

6. The system of claim 1, wherein each entity, in the plurality of clusters of entities, is a vehicle dealership; and
wherein the plurality of clusters of entities are clustered based on one or more characteristics that include at least one of:
a size of a vehicle inventory,
a makeup of the vehicle inventory,
a dealership score, or
a dealership location.

7. The system of claim 1, wherein the user profile information indicates a preferred user experience associated with an entity visit; and
wherein the one or more processors, to identify the entity, are configured to identify the entity based on the preferred user experience associated with the entity visit.

8. The system of claim 1, wherein the action is an exchange or an entity visit.

9. A method of using machine learning to predict an action, comprising:
inputting, by a system, a set of values, for a corresponding set of features, to a trained machine learning model that is trained to predict a likelihood that a user will perform the action in connection with one or more entities,
wherein the set of values are based on one or more interactions of the user with one or more user interfaces associated with a plurality of entities that include the one or more entities;
executing, by the system, the trained machine learning model on the set of values;
generating, by the system and based on executing the trained machine learning model on the set of values, an output indicative of the likelihood that the user will perform the action;
identifying, by the system, an entity, of the one or more entities, based on the output satisfying a threshold; and
providing, by the system, information to facilitate communication between the user and the entity based on identifying the entity.

10. The method of claim 9, wherein the entity is identified based on user profile information associated with the user.

11. The method of claim 9, wherein the entity is identified based on at least one value of the set of values.

12. The method of claim 9, further comprising:
applying a clustering model to generate a plurality of clusters of entities, wherein each cluster of entities includes a set of entities that share similar characteristics;
wherein the output indicates a likelihood that the user will perform the action in connection with one or more clusters of the plurality of clusters; and
wherein the entity is selected from a cluster, of the plurality of clusters, associated with a greater likelihood that the user will perform the action as compared to one or more other clusters included in the plurality of clusters.

13. The method of claim 12, wherein each entity, in the plurality of clusters of entities, is a vehicle dealership; and
wherein the plurality of clusters of entities are clustered based on one or more characteristics that include at least one of:
a size of a vehicle inventory,
a makeup of the vehicle inventory,
a dealership score, or
a dealership location.

14. The method of claim 9, wherein the output indicates the likelihood that the user will purchase a vehicle; and wherein the set of values includes at least one of:
a credit score of the user,
a loan amount associated with the user,
a maximum loan amount associated with the user,
an indication of whether the user has interacted with the one or more user interfaces to prequalify for a loan,
an indication of whether the user has interacted with a loan calculator presented via the one or more user interfaces,
an indication of whether the user has input a vehicle trade-in value via the one or more user interfaces, or
an indication of whether the user has interacted with a user interface, of the one or more user interfaces, that presents rebate information, warranty information, or insurance information.

15. A non-transitory computer-readable medium storing a set of instructions, the set of instructions comprising:
one or more instructions that, when executed by one or more processors of a system, cause the system to:
execute a trained machine learning model that is trained to predict a likelihood that a user will perform an action in connection with one or more entities,
wherein the trained machine learning model is executed using a set of values, for a corresponding set of features, that are based on one or more interactions of the user with one or more user interfaces associated with a plurality of entities that include the one or more entities;
generate, based on executing the trained machine learning model, an output that indicates the likelihood that the user will perform the action in connection with the one or more entities;
identify an entity, of the one or more entities, based on the output satisfying a threshold; and
provide information to facilitate communication between the user and the entity based on identifying the entity.

16. The non-transitory computer-readable medium of claim 15, wherein the one or more instructions further cause the system to:
receive a plurality of sets of historical values corresponding to a plurality of historical users,
wherein each set of historical values is based on one or more interactions of a historical user, of the plurality of historical users, with one or more user interfaces associated with the plurality of entities;
receive information indicating whether each of the plurality of historical users performed the action; and
generate the trained machine learning model based on the plurality of sets of historical values and the information indicating whether each of the plurality of historical users performed the action.

17. The non-transitory computer-readable medium of claim 15, wherein the entity is identified based on user profile information associated with the user or based on at least one value of the set of values.

18. The non-transitory computer-readable medium of claim 15, wherein the one or more instructions further cause the system to:
apply a clustering model to generate a plurality of clusters of entities, wherein each cluster of entities includes a set of entities that share similar characteristics;
wherein the output indicates a likelihood that the user will perform the action in connection with one or more clusters of the plurality of clusters; and
wherein the entity is selected from a cluster, of the plurality of clusters, associated with a greater likelihood that the user will perform the action as compared to one or more other clusters included in the plurality of clusters.

19. The non-transitory computer-readable medium of claim 18, wherein each entity, in the plurality of clusters of entities, is a vehicle dealership; and
wherein the plurality of clusters of entities are clustered based on one or more characteristics that include at least one of:
a size of a vehicle inventory,
a makeup of the vehicle inventory,
a dealership score, or
a dealership location.

20. The non-transitory computer-readable medium of claim 15, wherein the one or more instructions further cause the system to:
identify a contact method for the user based on at least one of:
user profile information associated with the user, or
applying the trained machine learning model or another trained machine learning model to the set of values; and
provide information that identifies the contact method in connection with the information to facilitate communication between the user and the entity.
